(19) United States
(12) Patent Application Publication
(10) Pub. No.: US 2020/0047737 A1
(43) Pub. Date: Feb. 13, 2020

(54) APPARATUS AND METHOD FOR CONTROLLING A TRACTION OF A VEHICLE

(71) Applicant: KNORR-BREMSE SYSTEME FUER NUTZFAHRZEUGE GMBH, Muenchen (DE)

(72) Inventor: Levente Balogh, Szigetszentimiklos (HU)

(21) Appl. No.: 16/344,696

(22) PCT Filed: Oct. 19, 2017
(86) PCT No.: PCT/EP2017/076765

§ 371 Date: Apr. 24, 2019

(30) Foreign Application Priority Data
Oct. 25, 2016 (EP) 16195472.2

(51) Int. Cl. B60W 10/18; B60T 8/1761; B60T 8/17

(52) U.S. Cl. CPC B60W 10/182; B60T 8/1701; B60T 8/1761

(57) ABSTRACT

An apparatus for controlling a traction of a vehicle, in which the vehicle includes a parking brake system with a spring-loaded brake cylinder operable to release the parking brake against a spring force using pressurized air and the parking brake system is configured to brake one or more driven wheels of the vehicle. The apparatus includes a data interface module and a braking control module. The data interface module is configured to receive input information depending on a wheel slip of the one or more wheels of the vehicle. The braking control module is configured to determine the wheel slip based on the received information and to control the parking brake system to keep the wheel slip below a threshold value, thereby controlling the traction of the vehicle.

### FIELD OF THE INVENTION

The present invention relates to an apparatus and a method for traction control of a vehicle and, in particular, to a method to override a driver parking brake demand in relation to a wheel slip for commercial vehicles.

### BACKGROUND INFORMATION

Many vehicles need to have two brake systems, one which is a service brake for normal braking actions and the other is the parking brake. Both brake systems are independent to ensure a secure stopping of the vehicle. If the service brake should fail, the parking brake acts as a secondary brake. For commercial vehicles parking brakes are often operated by pressurized air and may comprise spring-loaded brake cylinders, wherein the spring engages the brake automatically, if no sufficient air pressure is applied. The parking brake is released by applying compressed air to a spring-loaded brake cylinder to overcome the spring force. The permanently acting spring force ensures that the vehicle can only be moved during vehicle operations, whereas the parking brake remains securely applied otherwise.

An electronical control is more and more implemented also in parking brake systems of commercial vehicles. The electronic control allows and improves the operation of the parking brake. In conventional applications, the electronically controlled parking brake system is used for an automatic release or an automatic actuation of the parking brake. In addition to these applications, in situations, where the parking brake acts as a secondary braking system for the vehicle, still need further improvements.

However, any improvements for the parking brake have to take into account legal requirements. For example, the configuration shall ensure that the brake force is proportionally controllable by the driver to maintain the stability of the vehicle in case the secondary brake is employed, e.g. due to a failure of the primary brake. In addition, there are vehicles that fulfil the mandatory requirements by service brake ABS systems (ABS=anti-lock braking system) without an acceleration traction control feature by technically ensuring that a brake force different from the driver demand cannot be applied.

The employment of the parking brake during the motion of the vehicle is a rare situation. In most cases the parking brake is employed as a secondary braking system only if the service brake fails. As a result, the experience of the driver in controlling the braking force using the parking brake is limited—in particular when the driver attempts to keep the vehicle stable while actuating the parking brake lever. A loss of stability in such situations occurs frequently and represents an increasing security risk.

On the other hand, a vehicle system without an acceleration traction control can be very demanding for the driver too. In particular, slippery road situations do not only cause safety risks, but may likewise result in delivery delays and additional operational costs.

Although a slip control for braking is mandatory in many regions, a traction control system is often optional and thus not implemented—even in view of the increased safety risks and losses in the transportation robustness.

Therefore, there is a demand to implement a traction control system by a simple arrangement.

### SUMMARY OF THE INVENTION

At least some of the above-mentioned problems may be solved by an apparatus according to the description herein, a vehicle according to the description herein, and a method according to the description herein. The further descriptions herein relate to further specifically advantageous realizations.

The present invention relates to an apparatus for controlling a traction of a vehicle. The vehicle comprises a parking brake system with a spring-loaded brake cylinder operable to release the parking brake against a spring force using pressurized air. The parking brake system is configured to brake one or more driven wheels of the vehicle. The apparatus comprises a data interface module and a braking control module. The data interface module is configured to receive information depending on a wheel slip of the one or more (driven) wheels of the vehicle. The braking control module is configured to determine the wheel slip based on the received information and to control the parking brake system to keep the wheel slip below a threshold value, thereby controlling the traction of the vehicle. The traction control may further maintain a minimum wheel speed of at least one driven wheel.

It will be appreciated that a wheel slip can be positive or negative dependent on whether the vehicle is accelerating or decelerating. The threshold can thus relate either to a positive or to a negative slip value. Optionally, it is also possible that at least two thresholds define a slip range within which a slip of the driven wheels can be kept, wherein the zero value of the slip may not be included in the range to ensure an efficient acceleration. The braking control module may thus be configured to keep the wheel slip within a predefined slip range.

It is further understood that the parking brake can be used independently from the normal service brake used during normal driving operation. The spring-loaded cylinder comprises a chamber with a spring which ensures that the parking brake is employed and thus the vehicle is braked unless at least a minimum pressure is applied to the chamber to release the parking brake, thereby allowing the vehicle to be moved.

Optionally, the braking control module is configured to be operated without an input of a driver of the vehicle and/or to override a parking brake demand of the driver. For example, when starting the vehicle, the driver will release the parking brake and use the service brake during normal braking operations. However, during this normal driving operation of the vehicle, the apparatus may be configured to override the release demand of the driver in order to implement a traction control for the vehicle. As a consequence, the parking brake is not only used as a secondary braking system, but actively to implement the traction control. This is made possible if the parking brake is electronically controlled and not only by using a hand lever of the driver to release or to activate the parking brake. Since the traction control is implemented by using the parking brake (and not the service brake), the service brake can still be used for anti-lock actions (as ABS) independently of the parking brake. Since the parking brake is in most vehicles only implemented as a secondary braking system which is employed in case the normal service brake fails, it is not used over most times during normal operations of the vehicle and thus can be employed for the traction control without interfering it purpose.

Optionally, the braking control module is configured to control the parking brake to brake the one or more driven wheels differently from one of the other wheels of the vehicle. The traction control is typically implemented on wheels of a driven axle. Thus, by braking at least one wheel of the driven axle an applied momentum on all wheels of the driven axle can be equalized without the need to control the acceleration moment exerted by the engine on wheels of the driven axle. As a result, a yaw moment exerted on the vehicle can be controlled during the acceleration of the vehicle.

Of course, the wheel slip may be determined directly from a comparison of a rotational speed of the wheels as compared to a velocity of the vehicle. However, the apparatus does not necessarily need to determine or calculate the wheel slip itself. On the contrary, the apparatus may obtain this quantity from another control unit of the vehicle in order to act accordingly on at least one of the driven wheels. Therefore, the data interface module may further be configured to retrieve a value indicating a current wheel slip from a control unit of the vehicle.

The vehicle may further comprise a dynamic sensor operable to sense a yaw moment of the vehicle and the data interface module may further be configured to receive sensor data from the dynamic sensor. The braking control module may thus be configured to modify the threshold value for the wheel slip based on the yaw moment.

Furthermore, the vehicle may comprise a wheel speed sensor and/or a vehicle speed sensor, in which case the data interface module may be configured to receive data indicating the wheel speed and/or the vehicle speed, and the braking control module may be configured to determine the wheel slip as ratio of the wheel speed and the vehicle speed variable.

The vehicle may further comprise at least one of the following additional sensors: an engine speed, a transmission axle sensor, an odometer, a rotational speed sensor, wherein the at least one additional sensor is connected permanently or temporarily with one or more driven wheels. Accordingly, the data interface module may further be configured to receive additional sensor data from the at least one additional sensor, and the braking control module may be configured to determine the wheel speed based on the received additional sensor data.

Optionally, the vehicle further comprises at least one of the following supplemental sensors: a GPS sensor, an environment objection detection sensor. Accordingly, the data interface module may further be configured to receive supplemental sensor data from the at least one supplemental sensors, and the braking control module may further be configured to determine the vehicle speed based on the supplemental sensor data.

The present invention relates also to a vehicle comprising an apparatus as defined before and a parking brake system with a spring-loaded brake cylinder operable to release the parking brake against a spring force using pressurized air, wherein the parking brake system is configured to brake one or more driven wheels of the vehicle.

Optionally the vehicle includes at least one dynamic sensor or camera configured to determine at least one of the following: a wheel speed, a yaw rate, a steering angle, engine speed, vehicle speed, an object in an environment of the vehicle. The parking brake system may further be configured to control the air pressure wheel-dependent.

The present invention relates also to a method for controlling a traction of a vehicle, wherein the vehicle again comprises a parking brake system with a spring-loaded brake cylinder operable to release the parking brake against a spring force using pressurized air and the parking brake system is again configured to brake one or more driven wheels of the vehicle. The method comprises the steps of receiving information depending on a wheel slip of the one or more wheels of the vehicle, determining the wheel slip based on the received information, and controlling the parking brake system to keep the wheel slip below a threshold value, thereby controlling the traction of the vehicle.

This method may also be implemented in software or as a computer program product. Thus, the present invention relates also to a computer program product having a program code stored thereon for performing the above-mentioned method, when the computer program is executed on a computer or processor. In addition, all functions described previously in conjunction with the apparatus can be realized as further method steps and be implemented in software or software modules.

Embodiments of the present invention solve at least some of the above-mentioned problems by using the parking brake system of an exemplary commercial vehicle for a traction control. In contrast to known wheel slip control systems, which operate only during a braking operation, i.e. a deceleration of the vehicle, embodiments of the present invention use the parking brake in situations where the vehicle shall be accelerated while keeping control over the vehicle during slippery road situations. As a result, the apparatus according to the present invention shall not avoid a blocking of the wheels, but instead shall ensure a sufficient traction in order to accelerate the vehicle while preventing undesired yaw moments. In particular, a spinning of the wheels shall be omitted which would otherwise limit the wheel-road friction. Also a lateral support (to the left of the right-hand side of the vehicle) is compromised if the wheels are spinning and do not have a sufficient traction with the road.

Some examples of the system and/or methods will be described in the following by way of examples only, and with respect to the accompanying figures.

### BRIEF DESCRIPTION OF THE DRAWINGS

FIG. 1 depicts a commercial vehicle with an apparatus according to embodiments of the present invention.

FIG. 2 depicts the functional dependence of a friction between wheels and the road as a function of a slip.

FIG. 3 shows a flow chart of a method for controlling a traction of a vehicle according to embodiments of the present invention.

### DETAILED DESCRIPTION

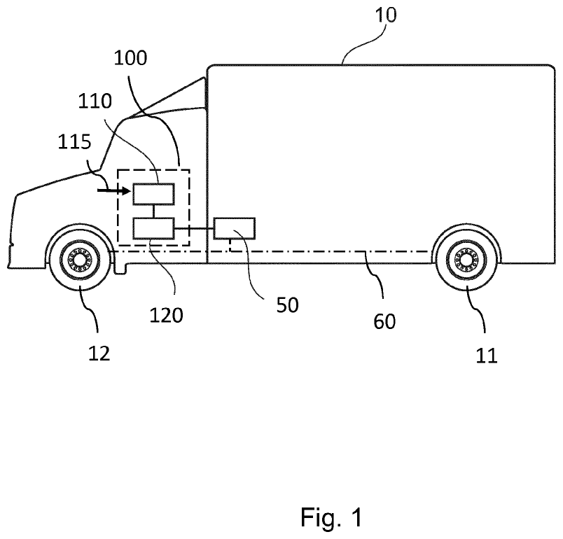

FIG. 1 depicts a commercial vehicle 10 with an apparatus 100 according to embodiments of the present invention. The vehicle 10 comprises a parking brake system 50 with a spring-loaded brake cylinder (not shown) operable to release the parking brake 50 against a spring force using pressurized air, and the parking brake system 50 is configured to brake one or more driven wheels 11 of the vehicle 10. However, the parking brake system 50 may be configured to control brake actuators not only on the driven wheels 11, but also on non-driven wheels 12 of the vehicle 10. For this, corresponding connections 60 are provided, which may include a wiring (e.g. a vehicle communication bus) and/or hydraulic lines and/or pneumatic lines.

The apparatus 100 comprises a data interface module 110 and a braking control module 120. The data interface module 110 is configured to receive input information 115 that depends on a wheel slip of the one or more wheels 11 of the vehicle 10. The braking control module 120 is configured to determine the wheel slip based on the received information and to control the parking brake system 50 to keep the wheel slip below a threshold value, thereby controlling a traction of the vehicle 10.

The parking brake system 50 may, in particular, be electronically controlled and operate the spring-loaded chamber (spring-loaded brake cylinder) with compressed air. The pressure in the chamber(s) may be controlled by solenoid valves according to a command from a control electronics, for example, connected to the vehicle communication bus 60. The command may comprise information about wheel speed(s). Therefore, the brake force of the spring brakes is maintained without a driver request of a parking brake operation and keeps the (rotational) speed of driven wheels 11 in a predefined slip range.

The vehicle 10 may further comprise vehicle dynamic sensor(s) for detecting a wheel speed, a yaw rate, a steering angle or an environment object. This dynamic sensor may, for example, include a radar, a camera, a Lidar, etc. Accordingly, the connections 60 may be used to communicate the respective sensor data from the vehicle dynamic sensor to a control unit or directly to the data interface module 110 as input information 115.

The parking brake system 50 may further be configured to set the (pneumatic) pressure of at least one wheel 11 of the driven axle differently than the pressure of the other wheels 12. This may be controlled by the braking control module 120.

According to embodiments, the wheel speed is determined based on sensor data of a rotational speed sensor(s) in the vehicle 10, which may couple to axles in a permanent or temporary connection with the driven wheels. This one or more rotational speed sensor can detect an engine speed by sensing the transmission axle. They may also be an odometer or a wheel speed sensor(s).

In yet another embodiment the vehicle speed can be detected by relying on external information. For example, the vehicle speed may be determined directly from or by combining sensors for evaluating speeds of various wheels and/or a GPS sensor (GPS=global positioning system) and/or environment object detection sensor. These sensors may be part of the mentioned vehicle dynamic sensor(s), but may also be stand-alone sensors. Again, they may communicate the respective sensor data to a control unit or directly to the data interface module 110 as input information 115, for example, using at least in part the connections 60.

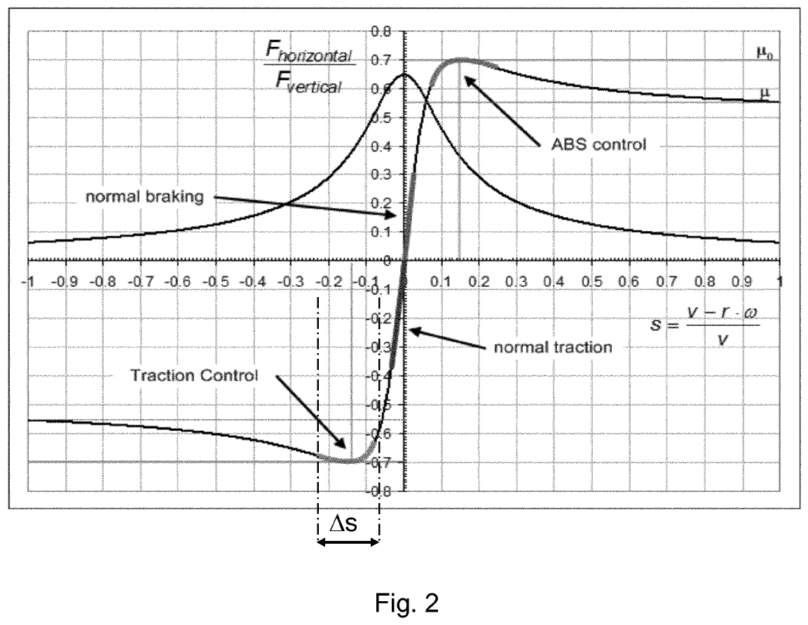

FIG. 2 depicts the functional dependence of a friction between wheels and the road as a function of a slip. The slip is defined by:

s=(v−r·ω)/v (1)

wherein v is the vehicle speed over the ground, r the radius and ω the angular velocity of the respective wheel that is in contact with the ground. Embodiment may use this definition or determine the slip s simply as the ratio of wheel speed r·ω and vehicle speed variables v.

The friction is defined as the ratio between the exerted horizontal force Fₕₒᵣ and the vertical force Fᵥₑᵣₜ and thus becomes 0 if no horizontal force is exerted, although wheels rotate (spinning wheels without any traction). The vertical force is basically given by the weight of the vehicle 10, whereas the horizontal force defines a desired braking or acceleration. The vertical force Fᵥₑᵣₜ is in most situations constant for a given vehicle (if the ground is flat), whereas the horizontal force Fₕₒᵣ has a maximum for a particular slip value.

In this notion, the braking of the vehicle 10 relates to positive values for the slip value s. In the example depicted in FIG. 2, the maximum horizontal force Fₕₒᵣ is achieved at about s=0.15. For higher slip values the horizontal force Fₕₒᵣ decreases and reaches asymptotically a value μ that depends on the road situation, the tires, weather conditions and other conditions.

As for the traction, the slip value s is negative. Also here, a maximum horizontal force Fₕₒᵣ (maximal acceleration for a given engine torque) is achieved for a slip value of about s=−0.15, whose absolute value again becomes smaller for more negative slip values. Therefore, the traction control is performed with the aim to get as close as possible to the maximum value for the negative horizontal force Fₕₒᵣ at about a slip value of s=−0.15. This ensures that the momentum exerted by the vehicle engine on the driven wheels 11 is used with a maximum efficiency to accelerate the vehicle 10. FIG. 2 further shows that the normal traction occurs at about s=0 where the vehicle is slowly accelerating with almost no slip.

The traction control is started when the slip “s” has reached an initial threshold value to optimize the transfer of the engine torque on the road and is kept in a slip range Δs, wherein the maximum of the longitudinal friction is within this slip range Δs (−0.23<s<−0.05). To utilize this slip range Δs the longitudinal force Fₕₒᵣ shall be controlled by a balance of the torque of the power train and the brakes. According to the present invention, the slip “s” can be maintained separately for each wheel of the driven axle—in particular adaptive to different road conditions of the wheels on each side, because the vehicle 10 enables an independent control of the parking brake force on the driven wheels 11.

Since the vehicle 10 comprises optional vehicle dynamic sensor(s) for detecting a yaw moment of the vehicle, the slip range Δs may be modified according to the detected yaw moment of the vehicle 10. These dynamic sensors may, for example, include a wheel speed sensor, a yaw rate sensor, a steering angle sensor or sensors which are able to measure a relative position of the vehicle in respect to non-moving objects (for example buildings, trees, bridges or other objects) around the vehicle.

The second curve in FIG. 2 (having a maximum at s=0) shows the lateral adhesion coefficient of the wheel and further illustrates that the lateral friction decreases by an increase in the longitudinal slip “s” resulting in potential lateral movements (to the side) and thus to a loss of stability. As the slip curve of the actual road can only be estimated, certain feedback measurements may be used in order to adapt the desired slip value “s” as a function of the yaw moment estimated by the vehicle dynamic sensors.

Once the desired slip value is determined, embodiments of the present invention operate the parking brake 50 without a driver request in order to control at least one wheel in accordance with the desired value. This way, a spinning of the driven wheels 11 is avoided and the longitudinal force can be maximized while the lateral force is kept on a level which is sufficient to keep the yaw rate of the vehicle 10 on the value which is intended by the driver.

In contrast to traction control functionalities implemented by service brake systems, embodiments do not require any additional components to be integrated—especially in case of an ABS system. However, an electronically controlled parking brake system 50 has all features needed to implement a traction control so that the service brake system is not needed for this functionality.

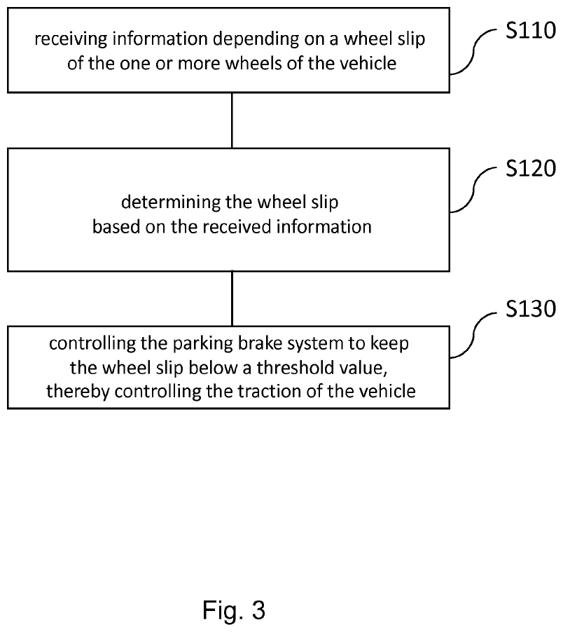

FIG. 3 shows a flow chart of a method for controlling a traction of a vehicle according to embodiments of the present invention. The method comprises the steps: receiving S110 information 115 depending on a wheel slip of the one or more wheels of the vehicle 10; determining S120 the wheel slip based on the received information; and controlling S130 the parking brake system 50 to keep the wheel slip below a threshold value, thereby controlling the traction of the vehicle 10.

Functions of the apparatus 100 as described previously may be implemented as further optional method steps. In addition, any defined function may be provided through the use of dedicated hardware, such as a control unit being capable of executing software in association with appropriate software. Therefore, the method according to the present invention may also be implemented in form of a computer program having a program code for performing the method, when the computer program is executed on a computer or processor. Moreover, any entity described herein as “module”, may correspond to or be implemented as “one or more modules”, “one or more devices”, “one or more units”, etc. It will further be appreciated that the apparatus 100 may be realized as part of one of the control units of the vehicle 10, for example by installing the appropriate software.

The description and drawings merely illustrate the principles of the disclosure. It will thus be appreciated that those skilled in the art will be able to devise various arrangements that, although not explicitly described or shown herein, embody the principles of the disclosure and are included within its scope.

Furthermore, while each embodiment may stand on its own as a separate example, it is to be noted that in other embodiments the defined features can be combined differently, i.e. a particular feature descripted in one embodiment may also be realized in other embodiments. Such combinations are covered by the disclosure herein unless it is stated that a specific combination is not intended.

The list of reference signs is as follows:
10 vehicle
11 one or more driven wheels
12 non-driven wheels
50 parking brake system
100 apparatus
115 input information
120 braking control module
Δs slip range
v vehicle speed

1-14. (canceled)

15. An apparatus for controlling a traction of a vehicle, comprising:
a data interface module to receive input information depending on a wheel slip of one or more wheels of the vehicle, wherein the vehicle includes a parking brake system with a spring-loaded brake cylinder operable to release the parking brake against a spring force using pressurized air, the parking brake system being configured to brake one or more driven wheels of the vehicle; and
a braking control module to determine the wheel slip based on the received information and to control the parking brake system to keep the wheel slip below a threshold value, so as to control the traction of the vehicle.

16. The apparatus of claim 15, wherein the braking control module is configured to operate without an input of the driver of the vehicle and/or to override a parking brake demand of the driver.

17. The apparatus of claim 15, wherein the braking control module is configured to control the parking brake system to brake the one or more driven wheels differently from one of the other wheels of the vehicle.

18. The apparatus of claim 15, wherein the braking control module is further configured to keep the wheel slip within a predefined slip range.

19. The apparatus of claim 15, wherein the data interface module is configured to retrieve a value indicating a current wheel slip from a control unit of the vehicle.

20. The apparatus of claim 15, wherein the vehicle includes a dynamic sensor operable to sense a yaw moment of the vehicle, wherein the data interface module is further configured to receive as input information sensor data from the dynamic sensor, and wherein the braking control module is configured to modify the threshold value for the wheel slip based on the yaw moment.

21. The apparatus of claim 15, wherein the vehicle includes a wheel speed sensor and a vehicle speed sensor, wherein the data interface module is configured to receive as input information further data indicating the wheel speed and the vehicle speed, and wherein the braking control module is configured to determine the wheel slip as a ratio of the wheel speed and the vehicle speed variable.

22. The apparatus of claim 21, wherein the vehicle further includes at least one of the following additional sensors: an engine speed sensor, a transmission axle sensor, an odometer, and a rotational speed sensor, wherein the at least one additional sensor couples permanently or temporarily with one or more driven wheels, wherein the data interface module is further configured to receive as input information additional sensor data from the at least one additional sensor, and wherein the braking control module is configured to determine the wheel speed based on the received additional sensor data.

23. The apparatus of claim 21, wherein the vehicle includes at least one of the following supplemental sensors: a GPS sensor, and an environment objection detection sensor, wherein the data interface module is further configured to receive as input information supplemental sensor data from the at least one supplemental sensors, and wherein the braking control module is configured to determine the vehicle speed based on supplemental sensor data.

24. A vehicle, comprising:
a parking brake system with a spring-loaded brake cylinder operable to release the parking brake against a spring force using pressurized air, the parking brake system being configured to brake one or more driven wheels of the vehicle; and
an apparatus for controlling a traction, including:
a data interface module to receive input information depending on a wheel slip of one or more wheels of the vehicle; and
a braking control module to determine the wheel slip based on the received information and to control the parking brake system to keep the wheel slip below a threshold value, so as to control the traction of the vehicle.

25. The vehicle of claim 24, further comprising:
at least one dynamic sensor or camera configured to determine at least one of the following: a wheel speed, a yaw rate, a steering angle, engine speed, vehicle speed, and an object in an environment of the vehicle.

26. The vehicle of claim 24, wherein the parking brake system is configured to control air pressure wheel-dependent.

27. A method for controlling a traction of a vehicle, the method comprising:
receiving input information depending on a wheel slip of the one or more wheels of the vehicle, wherein the vehicle includes a parking brake system with a spring-loaded brake cylinder operable to release the parking brake against a spring force using pressurized air, the parking brake system being configured to brake one or more driven wheels of the vehicle;
determining the wheel slip based on the received information; and
controlling the parking brake system to keep the wheel slip below a threshold value, thereby controlling the traction of the vehicle.

28. A non-transitory computer readable medium having a computer program, which is executable by a processor, comprising:
a program code arrangement having a program code for controlling a traction of a vehicle, by performing the following:
receiving input information depending on a wheel slip of the one or more wheels of the vehicle, wherein the vehicle includes a parking brake system with a spring-loaded brake cylinder operable to release the parking brake against a spring force using pressurized air, the parking brake system being configured to brake one or more driven wheels of the vehicle;
determining the wheel slip based on the received information; and
controlling the parking brake system to keep the wheel slip below a threshold value, thereby controlling the traction of the vehicle.
